(19) United States
(12) Patent Application Publication
(10) Pub. No.: US 2023/0289477 A1
(43) Pub. Date: Sep. 14, 2023

(54) INFORMATION PROCESSING APPARATUS, NON-TRANSITORY COMPUTER READABLE MEDIUM STORING INFORMATION PROCESSING PROGRAM, AND INFORMATION PROCESSING METHOD

(71) Applicant: FUJIFILM Business Innovation Corp., Tokyo (JP)

(72) Inventor: Akinori KASHIWAGI, Kanagawa (JP)

(73) Assignee: FUJIFILM Business Innovation Corp., Tokyo (JP)

(21) Appl. No.: 17/895,045

(22) Filed: Aug. 24, 2022

(30) Foreign Application Priority Data
Mar. 8, 2022 (JP) 2022-035271

(51) Int. Cl. G06F 21/62; G06F 21/60

(52) U.S. Cl. CPC G06F 21/629; G06F 21/604; G06F 21/6218

(57) ABSTRACT

An information processing apparatus includes a processor configured to: acquire authority setting information indicating an authority holder who has an authority for each of plural first authority setting items, for a first apparatus that is one of plural authority setting target apparatuses; acquire plural second authority setting items for which authorities are able to be set, for a second apparatus that is an apparatus other than the first apparatus, among the plural authority setting target apparatuses; and notify a user that authority division is not able to be performed in the second apparatus, in a case where authority holders of the second authority setting items are set to authority holders of the first authority setting items corresponding to the second authority setting items, shown in the authority setting information, and in a case where the respective authority holders of the plural second authority setting items are all the same.

### CROSS-REFERENCE TO RELATED APPLICATIONS

This application is based on and claims priority under 35 USC 119 from Japanese Patent Application No. 2022-035271 filed Mar. 8, 2022.

### BACKGROUND

### (i) Technical Field

The present invention relates to an information processing apparatus, a non-transitory computer readable medium storing an information processing program, and an information processing method.

### (ii) Related Art

In the related art, for an apparatus, an authority holder having an authority for each of a plurality of authority setting items has been set. In the present specification, an apparatus for which an authority is set as described above is referred to as an authority setting target apparatus. By setting the authority holder for the authority setting item and then applying the setting to the authority setting target apparatus, it is possible to prevent a user other than the authority holder from performing an operation on the authority setting item.

For example, JP2007-323324A discloses a device management system in which a role defining an operation authority for each operation item of a multi function peripheral (MFP), which is an authority setting target apparatus, is associated with a user, and in a case where the user operates the MFP, the user can execute only the operations indicated by the role associated with the user. Further, JP2007-323324A discloses that a system policy for limiting the operation authorities of all users can be set, and a part of the operation authorities set by the role can be limited by the system policy.

### SUMMARY

Incidentally, in a case where one authority setting target apparatus has a plurality of authority setting items, authority division may be performed in the authority setting target apparatus, from the viewpoint of security. The authority division means that the authority holders of the plurality of authority setting items possessed by the authority setting target apparatus are not all the same. The authority division is to be performed because in a case where the authority division is not performed and the authority of the authority holder is hijacked by a malicious user by some means, the malicious user can execute all the operations of the authority setting target apparatus.

On the other hand, it is assumed that a plurality of authority setting target apparatuses are operated. Although not limited to this, it is assumed that the authority setting target apparatus is an image forming apparatus, or a plurality of image forming apparatuses are installed and operated in a certain office. In a case where a plurality of authority setting target apparatuses are operated, the authority settings of the plurality of authority setting target apparatuses may be made same from each other, from the viewpoint of security or operation. Making the authority settings the same means that the authority holders of the corresponding authority setting items are the same among the plurality of authority setting target apparatuses.

Here, the authority setting items may differ from each other among the authority setting target apparatuses. In this case, on the premise that the authority settings in the plurality of authority setting target apparatuses are the same, even in a case of performing authority division in the first apparatus, which is one among the plurality of authority setting target apparatuses, authority division may not be performed in the second apparatus, which is an apparatus other than the first apparatus, among the plurality of authority setting target apparatuses.

For example, a case is considered where the first apparatus has authority setting items A and B and the second apparatus has only an authority setting item A. In this case, it is assumed that the authority holder A is set for the authority setting item A and the authority holder B is set for the authority setting item B, in the first apparatus. Thus, authority division is implemented in the first apparatus. However, in a case where the authority setting is the same for the first apparatus and the second apparatus, the second apparatus does not have the authority setting item B, so that in the second apparatus, only the authority holder A is set for the authority setting item A. Then, although the authority division is implemented in the first apparatus, the authority division is not implemented in the second apparatus.

Aspects of non-limiting embodiments of the present disclosure relate to an information processing apparatus, a non-transitory computer readable medium storing an information processing program, and an information processing method that on the premise that authority setting is the same in a first apparatus and a second apparatus which are authority setting target apparatuses, enable a user to understand that the authority division is not performed in the second apparatus in a case where the authority holder of each authority setting item is set such that the authority division is performed in the first apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a processor configured to: acquire authority setting information indicating an authority holder who has an authority for each of a plurality of first authority setting items, for a first apparatus that is one of a plurality of authority setting target apparatuses; acquire a plurality of second authority setting items for which authorities are able to be set, for a second apparatus that is an apparatus other than the first apparatus, among the plurality of authority setting target apparatuses; and notify a user that authority division is not able to be performed in the second apparatus, in a case where authority holders of the second authority setting items are set to authority holders of the first authority setting items corresponding to the second authority setting items, shown in the authority setting information, and in a case where the respective authority holders of the plurality of second authority setting items are all the same.

### BRIEF DESCRIPTION OF THE DRAWINGS

Exemplary embodiment(s) of the present invention will be described in detail based on the following figures, wherein:

FIG. 1 is a schematic configuration diagram of an information processing system according to the present exemplary embodiment;

FIG. 2 is a schematic configuration diagram of an authority setting target apparatus according to the present exemplary embodiment;

FIG. 3 is a diagram showing an example of authority setting information of a first apparatus;

FIG. 4 is a diagram showing an example of authority setting information of a second apparatus;

FIG. 5 is a diagram showing an example of an authority undivided notification screen;

FIG. 6 is a diagram showing an example of an authority setting screen;

FIG. 7 is a diagram showing an example of an authority division notification screen; and

FIG. 8 is a flowchart showing a processing flow of an information processing apparatus according to the present exemplary embodiment.

### DETAILED DESCRIPTION

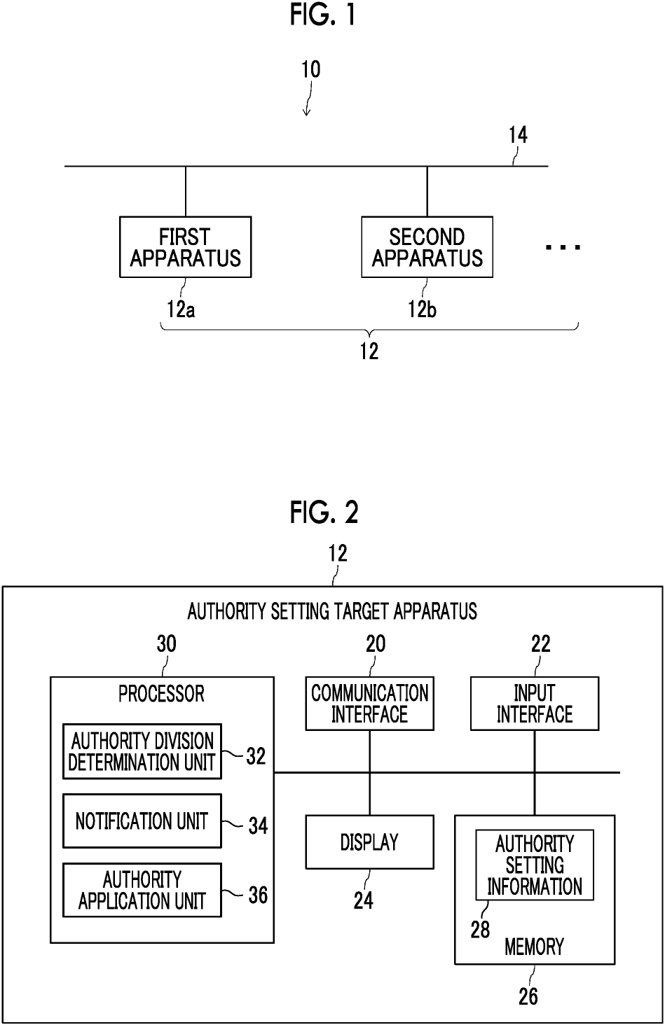

FIG. 1 is a schematic configuration diagram of an information processing system 10 according to the present exemplary embodiment. The information processing system 10 includes a plurality of authority setting target apparatuses 12. As described above, the authority setting target apparatus 12 is an apparatus for which an authority holder who has an authority for each of a plurality of authority setting items is set. The authority setting target apparatus 12 in the present exemplary embodiment is a multifunction device, a printer, a scanner, and the like, but the authority setting target apparatus 12 is not limited to these apparatuses. The plurality of authority setting target apparatuses 12 are connected to each other so as to be able to communicate with each other by a communication line 14 such as a local area network (LAN) or a wide area network (WAN).

As shown in FIG. 1, a plurality of authority setting target apparatuses 12 include a first apparatus 12a and a second apparatus 12b. The information processing system 10 may include three or more authority setting target apparatuses 12, but in the present specification, the processing of the information processing system 10 will be described by paying attention to the first apparatus 12a as an information processing apparatus and the second apparatus 12b that is the authority setting target apparatus 12 other than the first apparatus 12a. In a case where the first apparatus 12a and the second apparatus 12b are not particularly distinguished, the first apparatus 12a and the second apparatus 12b are collectively referred to as the authority setting target apparatus 12.

According to the rules regarding security in the environment in which the information processing system 10 is installed, it is required that the authority division is performed in each authority setting target apparatus 12 included in the information processing system 10. As described above, the authority division means that the authority holders of the plurality of authority setting items possessed by the authority setting target apparatus 12 are not all the same. Further, according to the rules regarding security or operation in the environment in which the information processing system 10 is installed, it is required that the authority settings in the respective authority setting target apparatuses 12 included in the information processing system 10 are the same as each other. As described above, making the authority settings the same means that the authority holders of the corresponding authority setting items are the same among the plurality of authority setting target apparatuses 12.

Therefore, the authority setter who sets the authority holder for each authority setting item of each authority setting target apparatus 12, such as the administrator of the information processing system 10, needs to set the authority holder for each authority setting item of each authority setting target apparatus 12 so as to satisfy the above two requirements. As will be described in detail later, the information processing system 10 supports the authority setter to set the authority holder for each authority setting item of each authority setting target apparatus 12 so as to satisfy the above two requirements.

FIG. 2 is a schematic configuration diagram of the authority setting target apparatus 12.

The communication interface 20 includes, for example, a network interface card (NIC). The communication interface 20 exhibits a function of communicating with another apparatus, particularly another authority setting target apparatus 12, via a communication line 14.

Examples of the input interface 22 include various buttons, and a touch panel. The input interface 22 is used to input an instruction from a user such as an authority setter to the authority setting target apparatus 12.

The display 24 includes, for example, a liquid crystal panel or an organic electro luminescence (EL) panel. Various screens are displayed on the display 24 in response to instructions from the processor 30 described later.

The memory 26 includes a hard disk drive (HDD), a solid state drive (SSD), an embedded multi media card (eMMC), a read only memory (ROM), a random access memory (RAM), and the like. The memory 26 stores an information processing program for operating each part of the authority setting target apparatus 12. In addition, the information processing program can also be stored in a computer-readable non-transitory storage medium such as a universal serial bus (USB) memory or a CD-ROM. The information processing system 10 can read and execute an information processing program from such a storage medium. Further, as shown in FIG. 2, the authority setting information 28 is stored in the memory 26.

The authority setting information 28 is information indicating a plurality of authority setting items possessed by the authority setting target apparatus 12 (in other words, the authority is able to be set in the authority setting target apparatus 12), and an authority holder having authority for each authority setting item. Although details will be described later, in the present exemplary embodiment, the processor 30 described later receives an authority setting instruction indicating an authority holder for each authority setting item possessed by the authority setting target apparatus 12 from the authority setter, and stores the authority setting information 28 of the contents indicated by the authority setting instruction in the memory 26.

The processor 30, which will be described later, authenticates the user of the authority setting target apparatus 12, and then refers to the authority setting information 28 to specify the operation authority of the authority setting target apparatus 12 of the user. Needless to say, in a case where the user performs an operation for which the user has the authority, the processor 30 executes the process corresponding to the operation. On the other hand, the processor 30 prohibits the user from performing an operation for which the user does not have the authority, or in a case where the user performs an operation for which the user does not have the authority, the processor 30 does not execute a process corresponding to the operation.

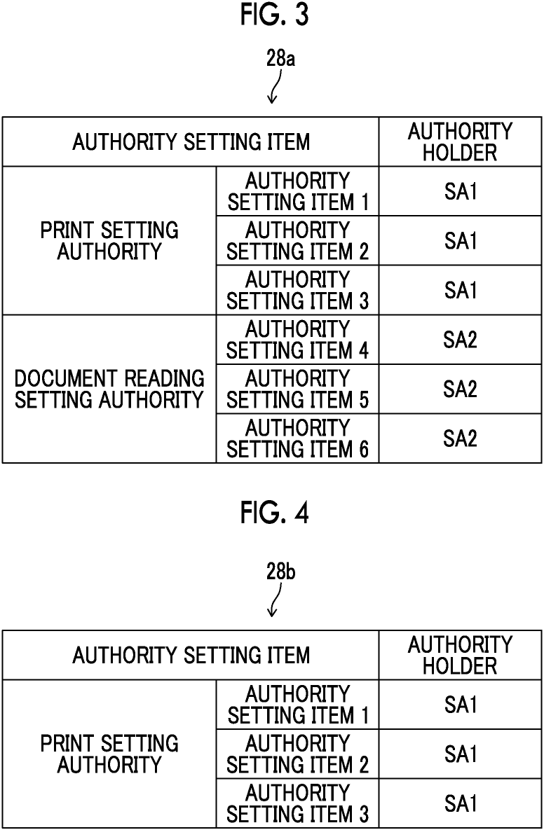

The plurality of authority setting items in the plurality of authority setting target apparatuses 12 may be different from each other due to the fact that the plurality of authority setting target apparatuses 12 have different functions from each other. FIG. 3 is a diagram showing the contents of the authority setting information 28a stored in the memory 26 of the first apparatus 12a, and FIG. 4 shows the contents of the authority setting information 28b stored in the memory 26 of the second apparatus 12b. In the present exemplary embodiment, the first apparatus 12a is a multifunction device, and the first apparatus 12a has a plurality of authority setting items 1 to 3 relating to the print setting authority relating to the printing function and a plurality of authority setting items 4 to 6 relating to the document reading setting authority relating to the document reading function. On the other hand, in the example of FIG. 4, the second apparatus 12b is a printer, and the second apparatus 12b has only a plurality of authority setting items 1 to 3 relating to the print setting authority related to the print function.

In the examples of FIGS. 3 and 4, roles such as “System Administrator (SA) 1” and “SA2” are associated with respective authority setting items. A user DB (not shown) in which each role is associated with one or a plurality of user IDs uniquely identifying a user is stored in another apparatus (for example, a server) accessible from the memory 26 or the authority setting target apparatus 12. The authority setting target apparatus 12 can identify the user associated with each authority setting item, by referring to the authority setting information 28 and the user DB. Of course, in the authority setting information 28, the user ID may be directly associated with each authority setting item.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed. As shown in FIG. 2, the processor 30 exhibits functions as an authority division determination unit 32, a notification unit 34, and an authority application unit 36, according to an information processing program stored in the memory 26.

In a case where the authority settings in the authority setting target apparatuses 12 included in the information processing system 10 are the same as each other, the authority division determination unit 32 executes an authority division determination process for determining whether or not authority division is to be performed in each of the plurality of authority setting target apparatuses 12 included in the information processing system 10. Here, focusing on the first apparatus 12a, which is one of the authority setting target apparatuses 12, the process of the authority division determination unit 32 of the first apparatus 12a will be described.

First, the authority setter sets the authority holder of each of the plurality of authority setting items 1 to 6 (see FIG. 3) of the first apparatus 12a, as the plurality of first authority setting items. Thus, the authority setting instruction indicating the authority holder of each of the set authority setting items 1 to 6 is sent to the processor 30. The authority setter may input the authority setting instruction by using the input interface 22, or may transmit the authority setting instruction to the first apparatus 12a from the user terminal used by the user. As described above, the first apparatus 12a has the authority setting items 1 to 6. Here, it is assumed that the authority setter sets the authority holders of the authority setting items 1 to 3 to “SA1” and sets the authority holders of the authority setting items 4 to 6 to “SA2”.

In addition, in the present specification, “setting” the authority holder means that the authority holder for the authority setting item is selected, and in the setting state, it is assumed that the authority holder is not stored in the memory 26 as the authority setting information 28. In other words, it is assumed that the authority holder is not reflected in the authority setting target apparatus 12 in the setting state. Storing the set authority holder in the memory 26 as the authority setting information 28 and making the processor 30 be operable based on the authority setting information 28, in other words, reflecting the authority holder in the authority setting target apparatus 12 are described as “applying” the authority holder, in the present specification.

In a case where the authority setting instruction is received from the authority setter, the authority division determination unit 32 determines whether or not the authority division is to be performed in the first apparatus 12a, in a case where the authority holder of each authority setting item of the first apparatus 12a is set as indicated by the authority setting instruction. Here, as described above, the authority setting instruction indicates that the authority holders of the authority setting items 1 to 3 are set to “SA1” and the authority holders of the authority setting items 4 to 6 are set to “SA2”, so that the authority division determination unit 32 determines that the authority division is performed in the first apparatus 12a according to the authority setting indicated by the authority setting instruction. In a case where the authority division is not performed in the first apparatus 12a according to the authority setting indicated by the authority setting instruction, in other words, the authority setting instruction indicates that the authority holders for all the authority setting items of the first apparatus 12a are the same, the notification unit 34, which will be described later, may output, a notification prompting the authority setter to reconsider the authority setting for the first apparatus 12a, by displaying a notification screen on the display 24 or the display of the user terminal of the authority setter.

In a case where it is determined that the authority division is performed in the first apparatus 12a according to the authority setting indicated by the authority setting instruction, the authority division determination unit 32 acquires a plurality of authority setting items possessed by the other authority setting target apparatus 12 included in the information processing system 10. Here, focusing on the second apparatus 12b, the authority division determination unit 32 acquires a plurality of authority setting items as a plurality of second authority setting items for the second apparatus 12b. Specifically, the authority division determination unit 32 transmits, to the second apparatus 12b, item request information for requesting a plurality of authority setting items of the second apparatus 12b. In response to the item request information from the first apparatus 12a, the processor 30 of the second apparatus 12b transmits information indicating a plurality of authority setting items of the second apparatus 12b (may be, for example, the authority setting information 28 stored in the memory 26 of the second apparatus 12b) to the first apparatus 12a.

In a case where a plurality of authority setting items of the second apparatus 12b are acquired from the second apparatus 12b, the authority division determination unit 32 sets the authority setting of the second apparatus 12b to be the same as the authority setting of the first apparatus 12a indicated by the authority setting instruction received from the authority setter. That is, the authority division determination unit 32 sets the authority holder of each authority setting item of the second apparatus 12b to the authority holder of the corresponding authority setting item of the first apparatus 12a, indicated by the authority setting instruction.

Here, it is assumed that the second apparatus 12b has the authority setting items 1 to 3 as a plurality of authority setting items. In this case, the authority division determination unit 32 sets the authority holder of the authority setting item 1 in the second apparatus 12b to “SA1” that is the authority holder of the authority setting item 1 of the first apparatus 12a indicated by the authority setting instruction. Similarly, the authority division determination unit 32 sets the authority holder of the authority setting item 2 to “SA1”, and sets the authority holder of the authority setting item 3 to “SA1”, respectively.

Next, the authority division determination unit 32 determines whether or not the authority division is performed in the second apparatus 12b in which the authority holder for each authority setting item is set as described above. In the above-described example, the same authority holder “SA1” is set for all of the plurality of authority setting items 1 to 3 possessed by the second apparatus 12b. Therefore, in this case, the authority division determination unit 32 determines that the authority division is not performed in the second apparatus 12b, in a case where the authority setting of the second apparatus 12b is set to be the same as the authority setting of the first apparatus 12a indicated by the authority setting instruction. On the other hand, in a case where the authority holders of the plurality of authority setting items 1 to 3 possessed by the second apparatus 12b are not all the same (in other words, the authority holder of at least one authority setting item is different from the authority holder of another authority setting item), the authority division determination unit 32 determines that the authority division is performed in the second apparatus 12b, in a case where the authority setting of the second apparatus 12b is set to be the same as the authority setting of the first apparatus 12a indicated by the authority setting instruction.

In a case where the authority division determination unit 32 determines that the authority division is not performed in the second apparatus 12b in a case where the authority setting of the second apparatus 12b is set to be the same as the authority setting of the first apparatus 12a indicated by the authority setting instruction, the notification unit 34 notifies the authority setter who has input the authority setting instruction to the first apparatus 12a that the authority division cannot be performed in the second apparatus 12b. In the present exemplary embodiment, the notification unit 34 provides a notification to the authority setter, by displaying an authority undivided notification screen on the display 24 or the display of the user terminal of the authority setter.

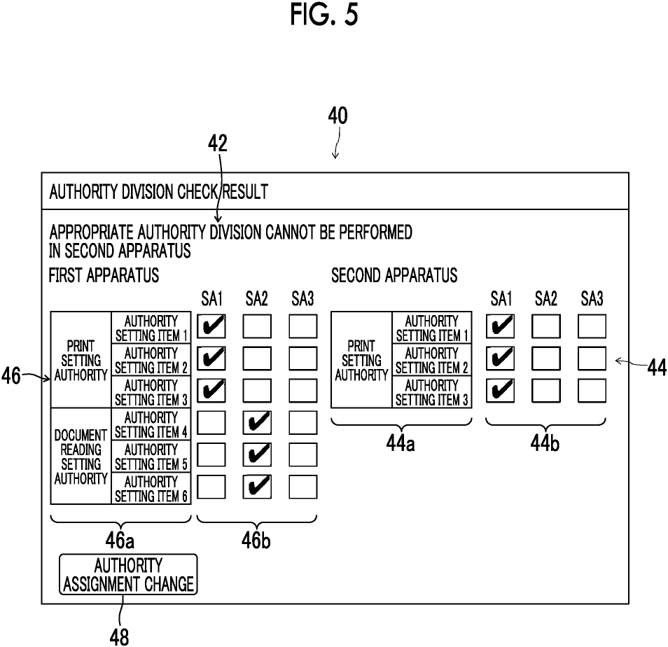

FIG. 5 is a diagram showing an example of an authority undivided notification screen 40. The authority undivided notification screen 40 may include a notification message 42 indicating that the authority division cannot be performed in the authority setting target apparatuses 12 other than the first apparatus 12a. In the notification message 42, another authority setting target apparatus 12 (second apparatus 12b in this example) in which the authority division could not be performed may be specified. Further, in addition to or in place of the notification message 42, the authority setting 44 of the authority setting target apparatus 12 (the second apparatus 12b in the present example) in which authority division could not be performed may be displayed on the authority undivided notification screen 40. Specifically, for example, a plurality of authority setting items 44a possessed by the second apparatus 12b and authority holders 44b for respective authority setting items 44a set by the authority division determination unit 32 may be shown. Further, the authority undivided notification screen 40 may show the authority setting 46 of the first apparatus 12a (contents of the authority setting instruction input to the first apparatus 12a by the authority setter). Specifically, a plurality of authority setting items 46a possessed by the first apparatus 12a and authority holders 46b for respective authority setting items 46a may be shown.

The user may easily know that the authority division is not performed in the second apparatus 12b from the authority undivided notification screen 40, in a case where the authority setting of the second apparatus 12b is set to be the same as the authority setting of the first apparatus 12a indicated by the authority setting instruction input by the user. The method of notifying the authority setter is not limited to the above method. For example, in addition to or instead of displaying the authority undivided notification screen 40, the notification may be performed by outputting voice from the speaker (not shown) of the first apparatus 12a or the speaker of the user terminal of the authority setter.

The authority undivided notification screen 40 may include an authority assignment change button 48. The authority setter can change the authority setting of the first apparatus 12a, by operating the authority assignment change button 48. Specifically, in a case where the authority assignment change button 48 is operated, the processor 30 displays the authority assignment change screen for changing (correcting) the authority setting of the first apparatus 12a on the display 24 or the display of the user terminal of the authority setter.

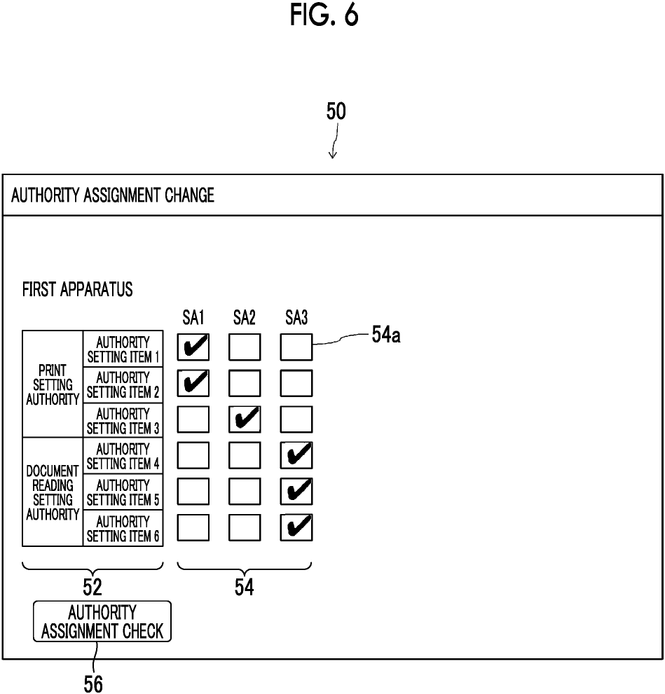

FIG. 6 is a diagram showing an example of an authority assignment change screen 50. The authority assignment change screen 50 includes a plurality of authority setting items 52 possessed by the first apparatus 12a, and an authority holder input portion 54 for inputting an authority holder for each of the authority setting items 52. In the example of FIG. 6, the authority holder input portion 54 includes a plurality of corresponding check boxes 54a respectively corresponding to a plurality of authority holders (“SA1”, “SA2”, and “SA3” in the example of FIG. 6) that can be input for respective authority setting items 52. The authority setter can change the authority holder for each authority holder input portion 54, by inputting a check in each check box 54a. Here, it is assumed that the authority setter changes the authority holder of the authority setting item 3 from “SA1” to “SA2”, and changes the authority holder of the authority setting items 4 to 6 from “SA2” to “SA3”.

The authority assignment change screen 50 may include an authority assignment check button 56. The authority setter can confirm whether or not the authority division is to be performed in the second apparatus 12b, in a case where the authority setting of the second apparatus 12b is set to be the same as the authority setting changed on the authority assignment change screen 50, by operating the authority assignment check button 56.

Specifically, in a case where the authority assignment check button 56 is operated, the processor 30 receives a correction authority setting instruction indicating the authority holder of each of the plurality of authority setting items of the first apparatus 12a, changed on the authority assignment change screen 50. Then, first, the authority division determination unit 32 determines whether or not the authority division is performed in the first apparatus 12a according to the authority setting indicated by the correction authority setting instruction. Even here, in a case where the authority division is not performed in the first apparatus 12a, the notification unit 34 may provide a notification to the authority setter. In a case where the authority division is performed in the first apparatus 12a according to the authority setting indicated by the correction authority setting instruction, the authority division determination unit 32 sets the authority holder of each authority setting item of the second apparatus 12b to the authority holder of the corresponding authority setting item of the first apparatus 12a, indicated by the correction authority setting instruction. Here, the authority holders of the authority setting items 1 and 2 in the second apparatus 12b are maintained at “SA1”, the authority holder of the authority setting item 3 is changed from “SA1” to “SA2”, and the authority holders of the authority setting items 4 to 6 are changed from “SA2” to “SA3”.

Next, the authority division determination unit 32 determines whether or not the authority division is to be performed in the second apparatus 12b, in a case where the authority setting of the second apparatus 12b is set to be the same as the authority setting of the first apparatus 12a indicated by the correction authority setting instruction. Here, the authority holder of the authority setting items 1 and 2 of the second apparatus 12b is “SA1”, but the authority holder of the authority setting item 3 is “SA2”. Therefore, in this case, the authority division determination unit 32 determines that the authority division is performed in the second apparatus 12b, in a case where the authority setting of the second apparatus 12b is set to be the same as the authority setting of the first apparatus 12a indicated by the correction authority setting instruction.

On the other hand, even in a case where the authority setting of the second apparatus 12b is set to be the same as the authority setting of the first apparatus 12a indicated by the correction authority setting instruction, in a case where the respective authority holders of the plurality of authority setting items 1 to 3 possessed by the second apparatus 12b are still the same, the notification unit 34 may notify the authority setter again that the authority division is not performed in the second apparatus 12b in a case where the authority setting of the second apparatus 12b is set to be the same as the authority setting of the first apparatus 12a indicated by the correction authority setting instruction. For example, the notification unit 34 displays the authority undivided notification screen 40 (see FIG. 5) again, on the display 24 or the display of the user terminal of the authority setter.

In a case where the authority division determination unit 32 determines that the authority division is performed in the second apparatus 12b in a case where the authority setting of the second apparatus 12b is set to be the same as the authority setting of the first apparatus 12a indicated by the authority setting instruction or the correction authority setting instruction, the notification unit 34 notifies the authority setter who has input the authority setting instruction to the first apparatus 12a that the authority division can be performed in the second apparatus 12b. In the present exemplary embodiment, the notification unit 34 provides a notification to the authority setter, by displaying an authority division notification screen on the display 24 or the display of the user terminal of the authority setter.

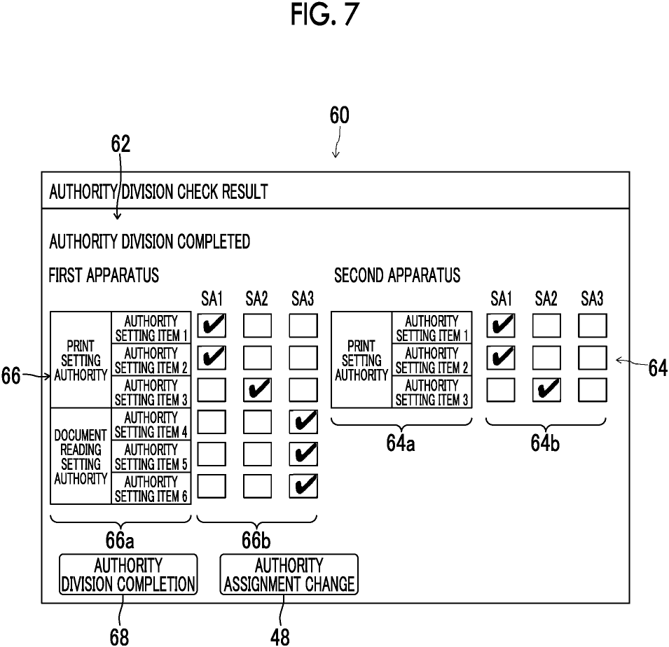

FIG. 7 is a diagram showing an example of the authority division notification screen 60. The authority division notification screen 60 may include a notification message 62 indicating that the authority division can be performed in the authority setting target apparatuses 12 other than the first apparatus 12a. Further, the authority division notification screen 60 may show the authority setting of a plurality of authority setting target apparatuses 12 in addition to or instead of the notification message 62. Specifically, a plurality of authority setting items 64a possessed by the second apparatus 12b and authority holders 64b for respective authority setting items 64a set by the authority division determination unit 32 may be shown. Further, the authority division notification screen 60 may show the authority setting 66 of the first apparatus 12a (contents of the authority setting instruction or the correction authority setting instruction input by the authority setter to the first apparatus 12a). Specifically, a plurality of authority setting items 66a possessed by the first apparatus 12a and authority holders 66b for respective authority setting items 66a may be shown.

The user may easily know that the authority division is performed in the second apparatus 12b from the authority division notification screen 60, in a case where the authority setting of the second apparatus 12b is set to be the same as the authority setting of the first apparatus 12a indicated by the authority setting instruction or the correction authority setting instruction input by the user. The method of notifying the authority setter is not limited to the above method. For example, in addition to or instead of displaying the authority division notification screen 60, the notification may be performed by outputting voice from the speaker (not shown) of the first apparatus 12a or the speaker of the user terminal of the authority setter.

Like the authority undivided notification screen 40, the authority division notification screen 60 may include the authority assignment change button 48. The authority setter can further change the authority setting of the first apparatus 12a, by operating the authority assignment change button 48. Further, the authority division notification screen 60 includes an authority division completion button 68. The operation when the authority division completion button 68 is operated will be described later.

In a case where the authority division determination unit 32 determines that the authority division is performed in the second apparatus 12b in a case where the authority setting of the second apparatus 12b is set to be the same as the authority setting of the first apparatus 12a indicated by the authority setting instruction or the correction authority setting instruction, the authority application unit 36 applies the authority holder of each of the plurality of authority setting items of the first apparatus 12a, as indicated by the authority setting instruction or the correction authority setting instruction from the authority setter, and applies the authority holder of each of the plurality of authority setting items of the second apparatus 12b set by the authority division determination unit 32, as the authority holder of each of the plurality of authority setting items of the second apparatus 12b.

Specifically, in a case where the authority setter operates the authority division completion button 68 on the authority division notification screen 60, the authority application unit 36 stores the authority holders for the plurality of authority setting items of the first apparatus 12a indicated by the authority setting instruction or the correction authority setting instruction from the authority setter, as the authority setting information 28 of the first apparatus 12a, in the memory 26 of the first apparatus 12a. Further, the authority application unit 36 transmits, to the second apparatus 12b, information indicating the authority holder of each of the plurality of authority setting items of the second apparatus 12b set by the authority division determination unit 32. According to the received information, the authority application unit 36 of the second apparatus 12b stores the authority holders for the plurality of authority setting items of the second apparatus 12b indicated by the information, as the authority setting information 28 of the second apparatus 12b, in the memory 26 of the second apparatus 12b.

The configuration of the information processing system 10 according to the present exemplary embodiment is as described above. In the present exemplary embodiment, the second apparatus 12b is described as the authority setting target apparatus 12 other than the first apparatus 12a, but the first apparatus 12a can execute a similar process for a plurality of authority setting target apparatuses 12 other than the first apparatus 12a.

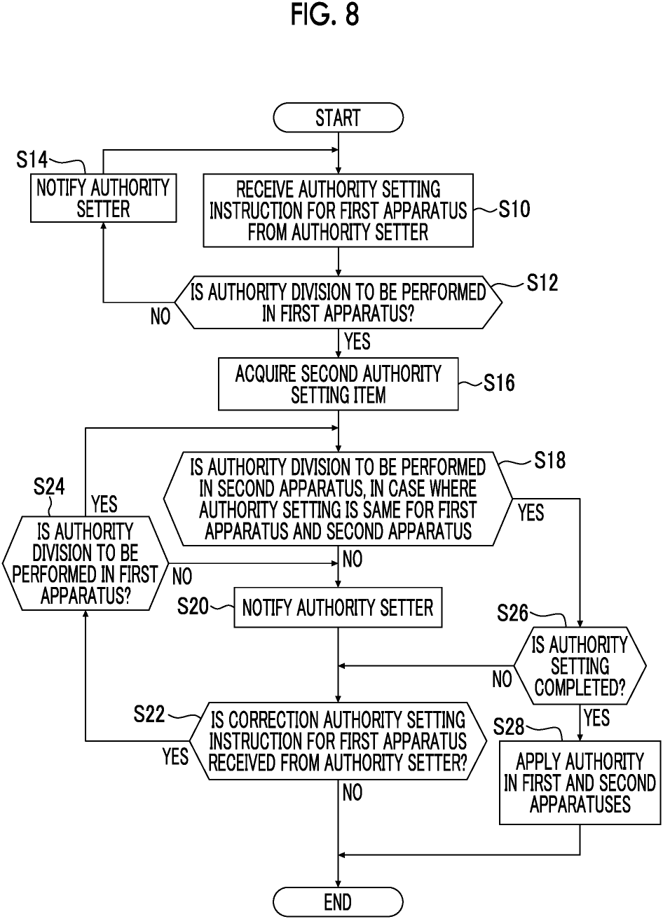

Hereinafter, the processing flow of the first apparatus 12a according to the present exemplary embodiment will be described with reference to the flowchart illustrated in FIG. 8.

In step S10, the first apparatus 12a receives, from the authority setter, an authority setting instruction indicating the authority holder of each of the plurality of authority setting items of the first apparatus 12a.

In step S12, the authority division determination unit 32 determines whether or not the authority division is to be performed in the first apparatus 12a, in a case where the authority holder of each authority setting item of the first apparatus 12a is set as indicated by the authority setting instruction received in step S10.

In a case where it is determined that the authority division is not performed in the first apparatus 12a, the process proceeds to step S14. In step S14, the notification unit 34 notifies the authority setter that the authority division is not performed in the first apparatus 12a in a case where the authority holder of each authority setting item of the first apparatus 12a is set as indicated by the authority setting instruction. The authority setter who has received the notification can review the authority setting of the first apparatus 12a, and input the authority setting instruction to the first apparatus 12a again in step S10.

In a case where it is determined that the authority division is performed in the first apparatus 12a, the process proceeds to step S16. In step S16, the authority division determination unit 32 acquires a plurality of authority setting items possessed by the second apparatus 12b.

In step S18, the authority division determination unit 32 executes an authority division determination process for determining whether or not the authority division is to be performed in the second apparatus 12b, in a case where the authority setting of the second apparatus 12b is set to be the same as the authority setting of the first apparatus 12a indicated by the authority setting instruction received in step S10.

In a case where it is determined that the authority division is not performed in the second apparatus 12b, the process proceeds to step S20. In step S20, the notification unit 34 notifies the authority setter that the authority division is not performed in the second apparatus 12b, in a case where the authority setting of the second apparatus 12b is set to be the same as the authority setting of the first apparatus 12a indicated by the authority setting instruction received in step S10.

In step S22, the authority division determination unit 32 determines whether or not the correction authority setting instruction indicating the changed authority setting for the first apparatus 12a has been received from the authority setter who has received the notification in step S20. In a case where a correction authority setting instruction is not received from the authority setter, the process ends.

In a case where the correction authority setting instruction is received from the authority setter, the process proceeds to step S24, and in step S24, the authority division determination unit 32 of the first apparatus 12a determines whether or not the authority division is to be performed in the first apparatus 12a, in a case where the authority holder of each authority setting item of the first apparatus 12a is set as indicated by the correction authority setting instruction received in step S22.

In a case where it is determined that the authority division is not performed in the first apparatus 12a, the process proceeds to step S20. In step S20 here, similarly to step S14, the notification unit 34 notifies the authority setter that the authority division is not performed in the first apparatus 12a, in a case where the authority holder of each authority setting item of the first apparatus 12a is set as indicated by the correction authority setting instruction. After that, the process proceeds to step S22 again, and the authority setter can further correct the correction authority setting instruction.

In a case where it is determined in step S24 that the authority division is performed in the first apparatus 12a, the process returns to step S18. In step S18 again, the authority division determination unit 32 determines whether or not the authority division is to be performed in the second apparatus 12b, in a case where the authority setting of the second apparatus 12b is set to be the same as the authority setting of the first apparatus 12a indicated by the correction authority setting instruction received in step S22.

In step S18, in a case where the authority setting of the second apparatus 12b is set to be the same as the authority setting of the first apparatus 12a indicated by the authority setting instruction or the correction authority setting instruction, and it is determined that the authority division is performed in the second apparatus 12b, the process proceeds to step S26.

In step S26, in a case where the authority setting of the second apparatus 12b is set to be the same as the authority setting of the first apparatus 12a indicated by the authority setting instruction and the correction authority setting instruction, the notification unit 34 notifies the authority setter that the authority division is performed in the second apparatus 12b, and the authority application unit 36 determines whether or not the authority settings of the plurality of authority setting target apparatuses 12 by the authority setter are completed. For example, the authority application unit 36 determines whether or not the authority division completion button 68 has been operated by the authority setter, on the authority division notification screen 60 (see FIG. 7). In a case where it is determined that the authority settings of the plurality of authority setting target apparatuses 12 by the authority setter are not completed (for example, in a case where the authority assignment change button 48 is operated on the authority division notification screen 60), the process returns to step S22, and the authority division determination unit 32 determines whether or not the correction authority setting instruction from the authority setter has been received.

In a case where it is determined that the authority settings of the plurality of authority setting target apparatuses 12 by the authority setter are completed, the process proceeds to step S28. In step S28, the authority application unit 36 stores the authority holders for the plurality of authority setting items of the first apparatus 12a indicated by the authority setting instruction received in step S10 or the correction authority setting instruction received in step S22, as the authority setting information 28 of the first apparatus 12a, in the memory 26 of the first apparatus 12a. Further, the authority application unit 36 transmits, to the second apparatus 12b, information indicating the authority holder of each of the plurality of authority setting items of the second apparatus 12b set by the authority division determination unit 32 in step S18. Upon receiving the information, the authority application unit 36 of the second apparatus 12b stores the authority holders for the plurality of authority setting items of the second apparatus 12b indicated by the information, as the authority setting information 28 of the second apparatus 12b, in the memory 26 of the second apparatus 12b.

Although the exemplary embodiments of the invention have been described above, the present invention is not limited to the above exemplary embodiments, and various modifications can be made without departing from the spirit of the present invention.

For example, in the above exemplary embodiment, the functions of the authority division determination unit 32, the notification unit 34, and the authority application unit 36 are possessed by the first apparatus 12a, which is one of the plurality of authority setting target apparatuses 12, but these functions may be possessed by an apparatus other than the plurality of authority setting target apparatuses 12, for example, a server communicably connected to the plurality of authority setting target apparatuses 12.

Further, in the above exemplary embodiment, the authority setting of the first apparatus 12a is set by the authority setter, but the authority setting of the first apparatus 12a may not be set by the authority setter. For example, the authority division determination unit 32 may determine whether or not the authority division is to be performed in the second apparatus 12b in a case where the authority setting of the second apparatus 12b is set to be the same as the initial authority setting of the first apparatus 12a, and the notification unit 34 may provide a notification to the user (for example, the administrator of the information processing system 10, or the like) according to the determination result. Alternatively, in a case where a computer such as a server automatically sets the authority of the first apparatus 12a according to a predetermined rule, the authority division determination unit 32 may determine whether or not the authority division is to be performed in the second apparatus 12b in a case where the authority setting of the second apparatus 12b is set to be the same as the automatically set authority setting of the first apparatus 12a, and the notification unit 34 may provide a notification to the user (for example, the administrator of the information processing system 10) according to the determination result.

Further, in the above exemplary embodiment, the authority division determination unit 32 executes the authority division determination process triggered by receiving the authority setting instruction indicating the authority holder of each of the plurality of authority setting items of the first apparatus 12a from the authority setter, but the execution timing of the authority division determination process is not limited to this. For example, in a state where the authority setting has already been applied in the first apparatus 12a, the authority division determination unit 32 may acquire the authority setting information 28 from the memory 26 and execute the authority division determination process, in response to an instruction from the user or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
acquire authority setting information indicating an authority holder who has an authority for each of a plurality of first authority setting items, for a first apparatus that is one of a plurality of authority setting target apparatuses;
acquire a plurality of second authority setting items for which authorities are able to be set, for a second apparatus that is an apparatus other than the first apparatus, among the plurality of authority setting target apparatuses; and
notify a user that authority division is not able to be performed in the second apparatus, in a case where authority holders of the second authority setting items are set to authority holders of the first authority setting items corresponding to the second authority setting items, shown in the authority setting information, and in a case where the respective authority holders of the plurality of second authority setting items are all the same.

2. The information processing apparatus according to claim 1, wherein the processor is configured to:
notify the user of the authority holders of the plurality of second authority setting items after the setting.

3. The information processing apparatus according to claim 2, wherein the processor is configured to:
receive, from the user who has received the notification, a correction authority setting instruction indicating a corrected authority holder of each of the plurality of first authority setting items, and
notify again the user that the authority division is not able to be performed in the second apparatus, in a case where the authority holders of the second authority setting items are set to the authority holders of the first authority setting items corresponding to the second authority setting items, shown in the correction authority setting instruction, and in a case where the respective authority holders of the plurality of second authority setting items are all the same.

4. The information processing apparatus according to claim 1, wherein the processor is configured to:
notify the user that the authority division is able to be performed in the second apparatus, in a case where the respective authority holders of the plurality of second authority setting items after the setting are not all the same.

5. The information processing apparatus according to claim 1, wherein the processor is configured to:
apply the respective authority holders of the plurality of second authority setting items after the setting as respective authority holders of the plurality of second authority setting items, in a case where the respective authority holders of the plurality of second authority setting items after the setting are not all the same.

6. The information processing apparatus according to claim 4, wherein the processor is configured to:
apply the respective authority holders of the plurality of second authority setting items after the setting as respective authority holders of the plurality of second authority setting items, in a case where the respective authority holders of the plurality of second authority setting items after the setting are not all the same.

7. The information processing apparatus according to claim 1,
wherein the information processing apparatus is the first apparatus.

8. The information processing apparatus according to claim 2,
wherein the information processing apparatus is the first apparatus.

9. The information processing apparatus according to claim 3,
wherein the information processing apparatus is the first apparatus.

10. The information processing apparatus according to claim 4,
wherein the information processing apparatus is the first apparatus.

11. The information processing apparatus according to claim 5,
wherein the information processing apparatus is the first apparatus.

12. The information processing apparatus according to claim 6,
wherein the information processing apparatus is the first apparatus.

13. A non-transitory computer readable medium storing an information processing program causing a computer to execute:
acquiring authority setting information indicating an authority holder who has an authority for each of a plurality of first authority setting items, for a first apparatus that is one of a plurality of authority setting target apparatuses;
acquiring a plurality of second authority setting items for which authorities are able to be set, for a second apparatus that is an apparatus other than the first apparatus, among the plurality of authority setting target apparatuses; and
notifying a user that authority division is not able to be performed in the second apparatus, in a case where authority holders of the second authority setting items are set to authority holders of the first authority setting items corresponding to the second authority setting items, shown in the authority setting information, and in a case where the respective authority holders of the plurality of second authority setting items are all the same.

14. An information processing method comprising:
acquiring authority setting information indicating an authority holder who has an authority for each of a plurality of first authority setting items, for a first apparatus that is one of a plurality of authority setting target apparatuses;
acquiring a plurality of second authority setting items for which authorities are able to be set, for a second apparatus that is an apparatus other than the first apparatus, among the plurality of authority setting target apparatuses; and
notifying a user that authority division is not able to be performed in the second apparatus, in a case where authority holders of the second authority setting items are set to authority holders of the first authority setting items corresponding to the second authority setting items, shown in the authority setting information, and in a case where the respective authority holders of the plurality of second authority setting items are all the same.
